(19) United States
(12) Patent Application Publication
(10) Pub. No.: US 2017/0052367 A1
(43) Pub. Date: Feb. 23, 2017

(54) LIGHT-SHIELDING PLATE ADAPTED TO LENS

(71) Applicant: Genius Electronic Optical Co., Ltd., Taichung City (TW)

(72) Inventor: Hung-Chang Cho, Fujian (CN)

(21) Appl. No.: 15/062,228

(22) Filed: Mar. 7, 2016

(30) Foreign Application Priority Data
Aug. 18, 2015 (CN) 201510508352.2

(51) Int. Cl. G02B 27/00

(52) U.S. Cl. CPC G02B 27/0018

(57) ABSTRACT

A light-shielding plate adapted to a lens is provided, which includes a light-shielding body, a light through hole penetrating through a center of the light-shielding body and at least one identification region penetratively disposed at a periphery of the light-shielding body. One of the at least one identification region includes a straight edge located at a boundary of the light-shielding body. The light-shielding plate satisfies: Rs/R≧0.8, where R is a radius of the light-shielding body, and Rs is the shortest distance between the identification region located closest to the light through hole and a circle center of the light through hole.

### CROSS-REFERENCE TO RELATED APPLICATION

This application claims the priority benefit of China application serial no. 201510508352.2, filed on Aug. 18, 2015. The entirety of the above-mentioned patent application is hereby incorporated by reference herein and made a part of this specification.

### BACKGROUND OF THE INVENTION

Field of the Invention

The invention relates to a light-shielding plate, and particularly relates to a light-shielding plate adapted to a lens.

Description of Related Art

In an imaging lens of the existing technique, a plurality of light-shielding plates are disposed between each two of the adjacent lenses to exclude stray lights, where the commonly used light-shielding plate is annular flat plate-shaped, and has a light through hole in the center, and a light passing through a clear aperture of the adjacent lenses may pass through the light through hole and is imaged on an imaging plane, and other lights are blocked or absorbed by the light-shielding plate.

However, during an element assembling process of the imaging lens, a problem that multiples light-shielding plates are stacked is probably occurred due to static electricity, which deviates from a correct optical design when more than one piece of the light-shielding plates are added between two adjacent lenses, and since front and back surfaces of each light-shielding plate respectively have different material properties, the front and back surfaces are probably misplaced during the assembling process, which may influence a light-shielding effect.

Referring to FIG. 1, in order to resolve the aforementioned problem, a light-shielding plate 1 applied to a camera lens of a related art includes a light-shielding body 11, a light through hole 12 penetrating through a center of the light-shielding body 11, and a main identification region 13 penetratively disposed at a periphery of the light-shielding body 11. A radius of the light-shielding body 11 is defined as r, and the shortest distance between the main identification region 13 and a circle center of light through hole 12 is rs, where r=4.086 mm, rs=3.103 mm, r−rs=0.983 mm, and rs/r=0.759, and since reflectively of light at the main identification region 13 of the stacked light-shielding plates is changed, it can be detei nined whether the light-shielding plates are stacked through visual determination according to computer images.

Moreover, the light-shielding plate 1 may further include a secondary identification region (not shown) penetratively disposed at the periphery of the light-shielding body 11, where a relative position angle between the main identification region 13 and the secondary identification region is not equal to 180 degrees, and the secondary identification region assist identifying whether the front and back surfaces of the light-shielding plate 1 are misplaced.

However, if the light-shielding plate 1 is applied to a lens with a smaller size (for example, a lens of a portable electronic device), the main identification region 13 is too close to the light through hole 12, which is liable to cause light leakage and a glare phenomenon to influence image quality.

### SUMMARY OF THE INVENTION

The invention is directed to a light-shielding plate adapted to a lens, which is capable of decreasing light leakage and a glare phenomenon and identifying a light-shielding plate stack phenomenon.

An embodiment of the invention provides a light-shielding plate adapted to a lens, which includes a light-shielding body, a light through hole penetrating through a center of the light-shielding body and at least one identification region penetratively disposed at a periphery of the light-shielding body, where one of the at least one identification region includes a straight edge located at a boundary of the light-shielding body.

The light-shielding plate adapted to the lens satisfies a following conditional: Rs/R≧0.8, where R is a radius of the light-shielding body, and Rs is the shortest distance between the identification region located closest to the light through hole and a circle center of the light through hole.

An embodiment of the invention provides another light-shielding plate adapted to a lens, which is capable of decreasing light leakage and a glare phenomenon and identifying a light-shielding plate stack phenomenon.

The light-shielding plate adapted to a lens includes a light-shielding body, a light through hole penetrating through a center of the light-shielding body and at least one identification region penetratively disposed at a periphery of the light-shielding body.

The light-shielding plate adapted to the lens satisfies following conditionals: Rs/R≧0.8, R≦3 mm, and R₀≦1.5 mm, where R is a radius of the light-shielding body, Rs is the shortest distance between the identification region located closest to the light through hole and a circle center of the light through hole, and R₀ is a radius of the light through hole.

According to the above descriptions, the embodiments of the invention have following effects: by configuring at least one identification region at the periphery of the light-shielding body, whether the light-shielding plates are stacked can be determined through visual determination according to computer images during an assembling process, and by satisfying the aforementioned conditionals, the at least one identification region is located farther from the light through hole, so as to achieve the effect of decreasing the light leakage and glare phenomenon.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a light-shielding plate adapted to a camera lens according to a related art.

FIG. 2 is a schematic diagram of a light-shielding plate adapted to a lens according to a first embodiment of the invention.

FIG. 3 illustrates a situation that the light-shielding plate of the first embodiment is stacked with another light-shielding plate.

FIG. 4 is a schematic diagram of a light-shielding plate adapted to a lens according to a second embodiment of the invention.

FIG. 5 is a schematic diagram of a light-shielding plate adapted to a lens according to a third embodiment of the invention.

FIG. 6 is a schematic diagram of a light-shielding plate adapted to a lens according to a fourth embodiment of the invention.

FIG. 7 is a schematic diagram of a light-shielding plate adapted to a lens according to a fifth embodiment of the invention.

FIG. 8 is a schematic diagram of a light-shielding plate adapted to a lens according to a sixth embodiment of the invention.

### DESCRIPTION OF EMBODIMENTS

The accompanying drawings are included to provide a further understanding of the invention, and are incorporated in and constitute a part of this specification. The drawings illustrate embodiments of the invention and, together with the description, serve to explain the principles of the invention. By referring to the following content, those with ordinary skills in the art should understand other possible embodiments and the advantages of the invention. The components in the drawings are not drawn to scale, and the same reference numbers are used in the drawings and the description to refer to the same or like parts.

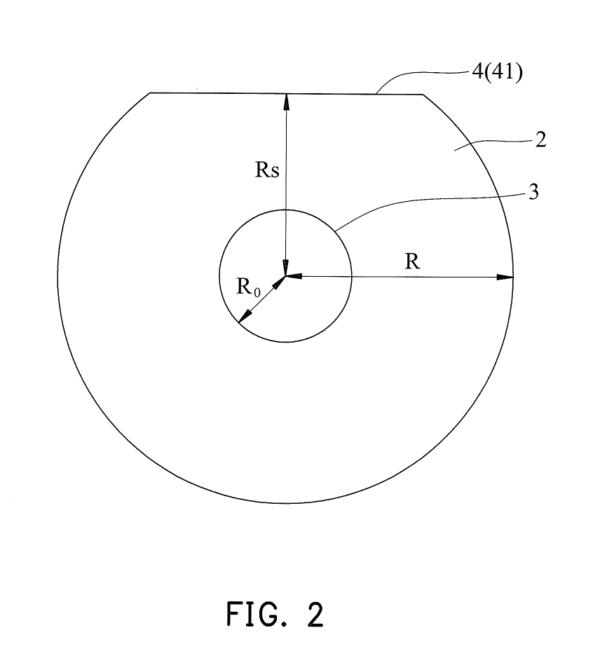

Referring to FIG. 2, a light-shielding plate adapted to a lens of a first embodiment of the invention includes a light-shielding body 2, a light through hole 3 penetrating through a center of the light-shielding body 2 and a first identification region 4 penetratively disposed at a periphery of the light-shielding body 2. The first identification region 4 includes a straight edge 41 located at a boundary of the light-shielding body 2.

The light-shielding plate adapted to the lens satisfies following conditionals:

Rs/R≧0.8 (1)

R−Rs≦0.4 mm (2)

R≦3 mm (3)

R₀≦1.5 mm (4)

where R is a radius of the light-shielding body 2, Rs is the shortest distance between the first identification region 4 and a circle center of the light through hole 3, and R₀ is a radius of the light through hole 3. In the present embodiment, R=1.825 mm, R₀=0.53 mm, Rs=1.46 mm, and based on calculation, R−Rs=0.365 mm, and Rs/R=0.8.

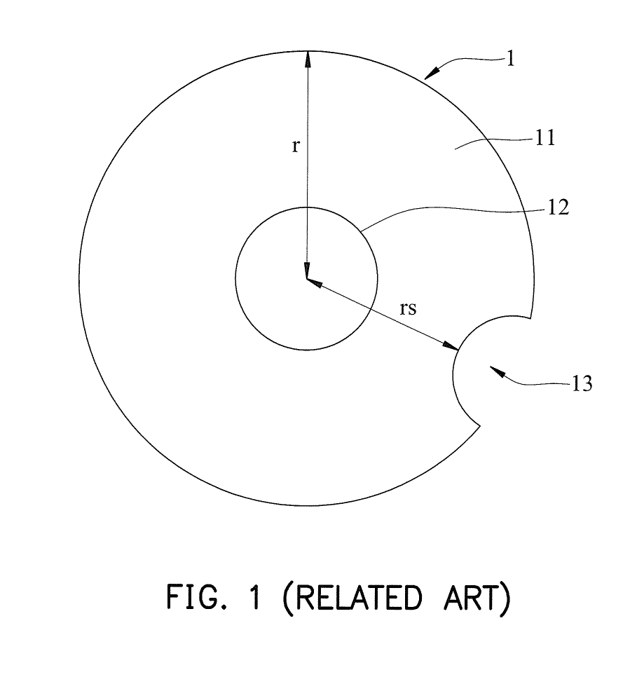

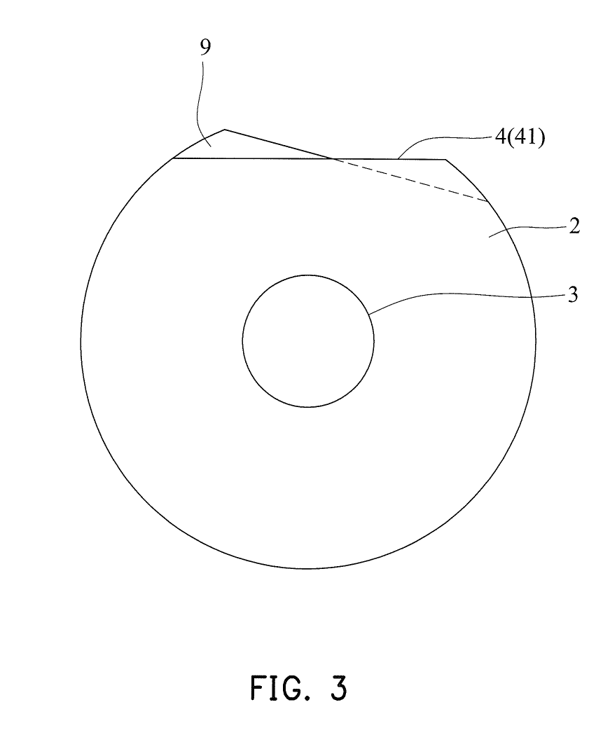

By configuring the first identification region 4 at the periphery of the light-shielding body 2, as shown in FIG. 3, whether the light-shielding plate of the present embodiment is stacked with another light-shielding plate 9 can be determined through visual determination according to computer images, and compared to the related art (shown in FIG. 1), the first identification region 4 is located farther away from the light through hole 3 according to the conditional (1) and the conditional (2), such that light leakage and a glare phenomenon can be effectively decrease to maintain imaging quality. Moreover, according to the conditional (3) and the conditional (4), the light-shielding plate of the embodiment of the invention can be applied to lenses with a smaller size (for example, lenses of portable electronic devices).

It should be noted that when the first identification region 4 is an edge-cutting structure including the straight edge 41, under a condition that the first identification region 4 has a same identification degree with another identification region having a same area size, the design of the edge-cutting structure ensures that the shortest distance Rs between the first identification region 41 and the circle center of the light through hole 3 is the longest, so as to decrease the light leakage and glare phenomenon. Further, when the first identification region 4 is the edge-cutting structure including the straight edge 41, when Rs/R=0.95, effective identification can still be achieved; and when Rs/R is greater than 0.95, even if the first identification region 4 is the edge-cutting structure, the area size of the identification region is inadequate for implementing identification, and manufacturing difficulty is relatively increased.

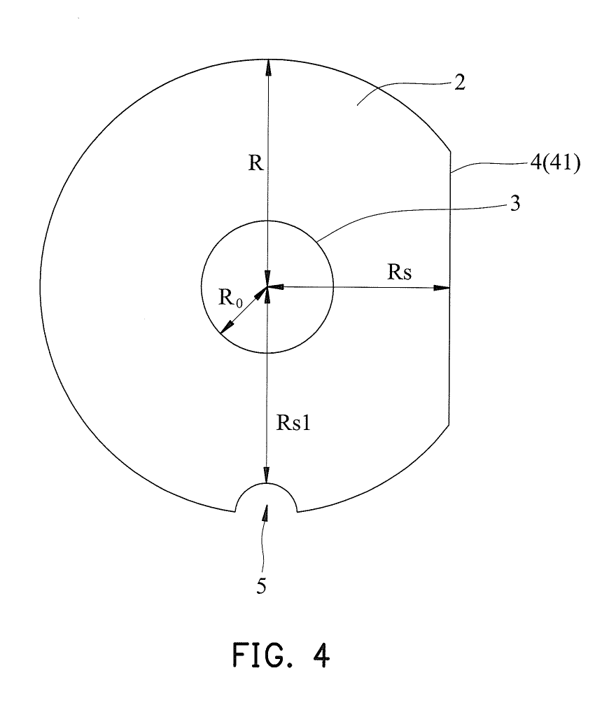

Referring to FIG. 4, FIG. 4 is a schematic diagram of a light-shielding plate adapted to a lens according to a second embodiment of the invention. The second embodiment is similar to the first embodiment, the radius of the light-shielding body 2 is R=1.825 mm, the radius of the light through hole 3 is R₀=0.53 mm, and a main difference therebetween is that the present embodiment further includes a second identification region 5 spaced from the first identification region 4 and penetratively disposed at the periphery of the light-shielding body 2. The first identification region 4 is closer to the light through hole 3 compared to the second identification region 5, and a relative position angle between the first identification region 4 and the second identification region 5 on the light-shielding body 2 is not equal to 180 degrees, i.e. an included angle between a direction from the center of the light-shielding body 2 to the first identification region 4 and a direction from the center of the light-shielding body 2 to the second identification region 5 is not equal to 180 degrees.

In the present embodiment, the shortest distance Rs between the first identification region 4 and the circle center of the light through hole 3 is Rs=1.46 mm, and based on calculation, R−Rs=0.365 mm, and Rs/R=0.8; the shortest distance Rs1 between the second identification region 5 and the circle center of the light through hole 3 is Rs1=1.575 mm, and based on calculation, R−Rs1=0.25 mm, and Rs1/R=0.86, which are all complied with the aforementioned conditionals (1)-(4), so that the second embodiment have the same effects with that of the first embodiment.

Moreover, by configuring the second identification region 5 at the periphery of the light-shielding body 2, and based on the condition that the relative position angle between the first identification region 4 and the second identification region 5 on the light-shielding body 2 is not equal to 180 degrees, second identification region 5 may assist identifying whether the front and back surfaces of the light-shielding plate of the present embodiment are misplaced during the component assembling process.

It should be noted that the second identification region 5 is a round-cutting structure, and compared to the round-cutting structure of the second identification region 5, the straight edge 41 of the first identification region 4 is easier for identification when determining whether the light-shielding plates are stacked through visual determination of computer images, and when the area sizes of the first identification region 4 and the second identification region 5 are the same, as the straight edge 41 of the first identification region 4 is farther from the light through hole 3, the light leakage and the glare phenomenon are effectively decreased. However, shapes of the first identification region 4 and the second identification region 5 are not limited thereto.

Moreover, in an variation of the present embodiment, the shortest distance Rs between the first identification region 4 and the circle center of the light through hole 3 is Rs=1.55 mm, and based on calculation, R−Rs=0.275 mm, and Rs/R=0.85, which is also complied with the aforementioned conditionals (1)-(4), so that such variation may also achieve the aforementioned effects.

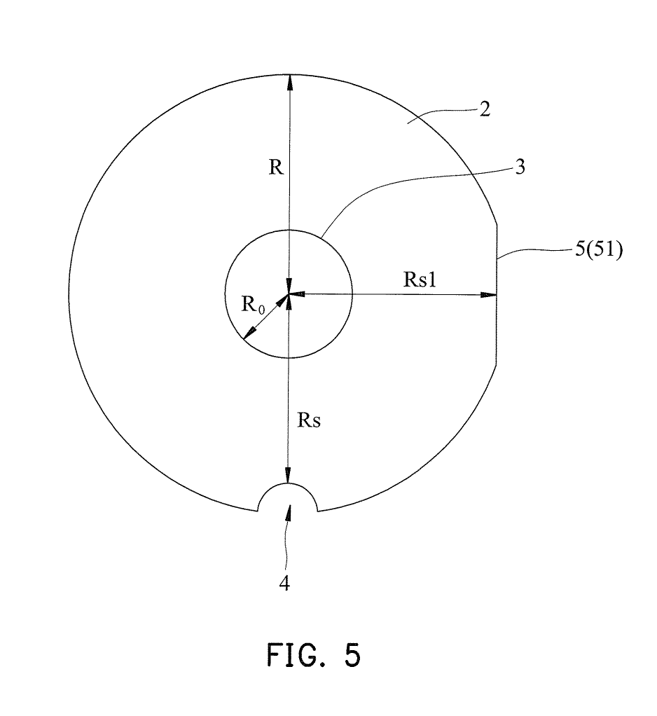

Referring to FIG. 5, FIG. 5 is a schematic diagram of a light-shielding plate adapted to a lens according to a third embodiment of the invention, the third embodiment is similar to the second embodiment, the radius of the light-shielding body 2 is R=1.825 mm, the radius of the light through hole 3 is R₀=0.53 mm, and the first identification area 4 is closer to the light through hole 3 compared to the second identification region 5, and a main difference therebetween is that the first identification region 4 of the third embodiment is a round-cutting structure, and the second identification region 5 includes a straight edge 51 located at a boundary of the light-shielding body 2.

In the present embodiment, the shortest distance Rs between the first identification region 4 and the circle center of the light through hole 3 is Rs=1.575 mm, and based on calculation, R−Rs=0.25 mm, and Rs/R=0.86, the shortest distance Rs1 between the second identification region 5 and the circle center of the light through hole 3 is Rs1=1.73 mm, and based on calculation, R−Rs1=0.095 mm, and Rs1/R=0.95, which are all complied with the aforementioned conditionals (1)-(4).

Moreover, in a variation of the present embodiment, the shortest distance Rs1 between the second identification region 5 and the circle center of the light through hole 3 is Rs1=1.64 mm, and based on calculation, R−Rs1=0.185 mm, Rs1/R=0.90, which is also complied with the aforementioned conditionals (1)-(4), so that such variation may also achieve the aforementioned effects.

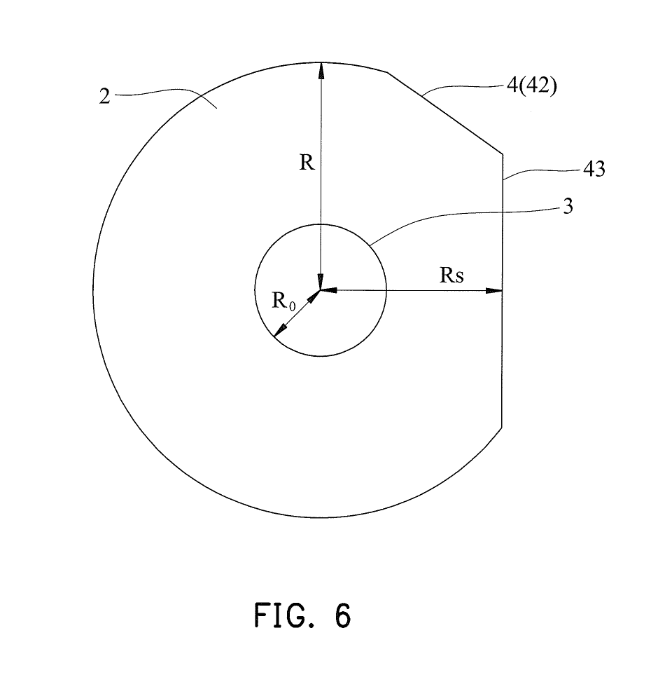

Referring to FIG. 6, FIG. 6 is a schematic diagram of a light-shielding plate adapted to a lens according to a fourth embodiment of the invention, the fourth embodiment is similar to the first embodiment, the radius of the light-shielding body 2 is R=1.825 mm, the radius of the light through hole 3 is R₀=0.53 mm, and a main difference therebetween is that the first identification region 4 of the fourth embodiment includes a short straight edge 42 located at a boundary of the light-shielding body 2 and a long straight edge 43 connected to the short straight edge 42 and the light-shielding body 2, where a length of the long straight edge 43 is longer than a length of the short straight edge 42.

In the present embodiment, the shortest distance Rs between the first identification region 4 and the circle center of the light through hole 3 is Rs=1.64 mm, and based on calculation, R−Rs=0.185 mm, Rs/R=0.90, which is also complied with the aforementioned conditionals (1)-(4).

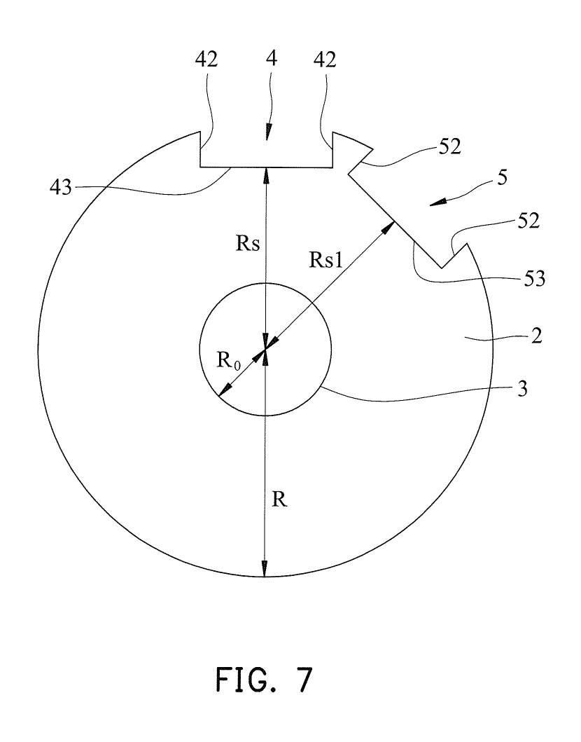

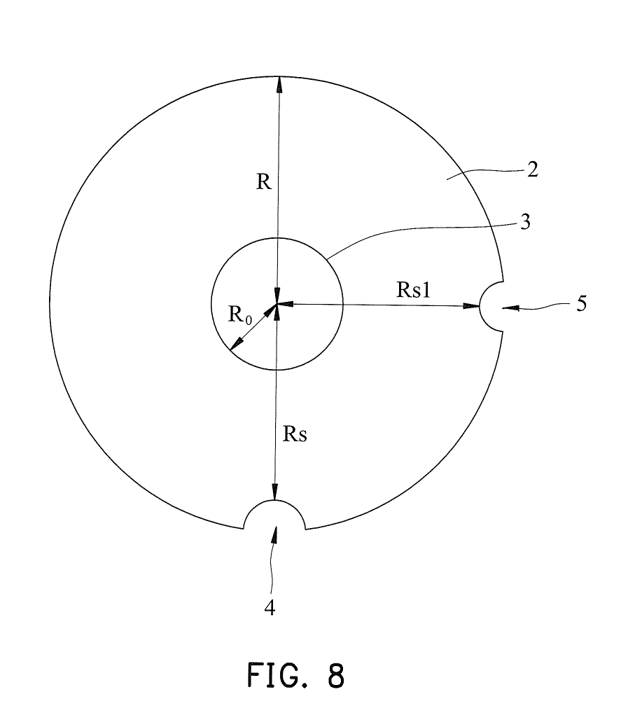

It should be noted that besides that the first identification region 4 can be used for determining a light-shielding plate stack phenomenon to achieve the effect of decreasing the light leakage and glare phenomenon, meanwhile, based on different lengths of the short straight edge 42 and the long straight edge 43 of the first identification region 4, the function of identifying the front and back surfaces of the light-shielding plate is achieved without configuring the second identification region 5 shown in FIG. 4, FIG. 5, FIG. 7 or FIG. 8. Moreover, since the first identification region 4 has a simple structure, it is easy to be manufactured, identified and is not easy to be damaged during the assembling process.

Referring to FIG. 7, FIG. 7 is a schematic diagram of a light-shielding plate adapted to a lens according to a fifth embodiment of the invention, the fifth embodiment is similar to the second embodiment, the radius of the light-shielding body 2 is R=1.825 mm, the radius of the light through hole 3 is R₀=0.53 mm, and a main difference therebetween is that each of the first identification region 4 and the second identification region 5 of the fifth embodiment includes a pair of short straight edges 42 (52) located at a boundary of the light-shielding body 2 and spaced from each other and a long straight edges 43 (53) connected to the short straight edges 42 (52) through two ends thereof, where a length of the long straight edge 43 (53) is longer than a length of each of the short straight edges 42 (52).

In the present embodiment, the shortest distance Rs between the first identification region 4 and the circle center of the light through hole 3 is Rs=1.46 mm, and based on calculation, R−Rs=0.365 mm, Rs/R=0.8; the shortest distance Rs1 between the second identification region 5 and the circle center of the light through hole 3 is Rs1=1.46 mm, and based on calculation, R−Rs1=0.365 mm, Rs1/R=0.8, which are all complied with the aforementioned conditionals (1)-(4).

Referring to FIG. 8, FIG. 8 is a schematic diagram of a light-shielding plate adapted to a lens according to a sixth embodiment of the invention, the sixth embodiment is similar to the second embodiment, the radius R of the light-shielding body 2 is R=1.825 mm, the radius R₀ of the light through hole 3 is R₀=0.53 mm, and the first identification area 4 is closer to the light through hole 3 compared to the second identification region 5, and a main difference therebetween is that the first identification region 4 and the second identification region 5 of the sixth embodiment are all round-cutting structures, the shortest distance Rs between the first identification region 4 and the circle center of the light through hole 3 is Rs=1.575 mm, and based on calculation, R−Rs=0.25 mm, and Rs/R=0.86; the shortest distance Rs1 between the second identification region 5 and the circle center of the light through hole 3 is Rs1=1.625 mm, and based on calculation, R−Rs1=0.2 mm, and Rs1/R=0.89, which are all complied with the aforementioned conditionals (1)-(4).

According to the above descriptions, the embodiments of the invention have following advantages:

1. By configuring the first identification region 4 at the periphery of the light-shielding body 2, whether the light-shielding plate is stacked with another light-shielding plate 9 can be determined, and by satisfying the conditionals (1) and (2), the first identification region 4 is located farther from the light through hole 3 compared to the related art, so as to achieve the effect of decreasing the light leakage and glare phenomenon.

2. A product specification may be limited according to the conditionals (3) and (4), which is adapted to the lenses with a smaller size.

3. When the first identification region 4 is the edge-cutting structure including the straight edge 41, under a condition that the first identification region 4 has a same identification degree with another identification region having a same area size, the design of the edge-cutting structure ensures that the shortest distance Rs between the first identification region 41 and the circle center of the light through hole 3 is the longest, so as to decrease the light leakage and glare phenomenon to improve imaging quality.

4. By configuring the second identification region 5 at the periphery of the light-shielding body 2, and based on the condition that the relative position angle between the first identification region 4 and the second identification region 5 on the light-shielding body 2 is not equal to 180 degrees (i.e. an included angle between a direction from the center of the light-shielding body 2 to the first identification region 4 and a direction from the center of the light-shielding body 2 to the second identification region 5 is not equal to 180 degrees), the second identification region 5 may assist identifying whether the front and back surfaces of the light-shielding plate of the invention are misplaced.

5. When the first identification region 4 adopts a shape including the short straight edge 42 and the long straight edge 43, the light-shielding plate has effects of easy identification, easy fabrication, stable structure, etc.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A light-shielding plate adapted to a lens, comprising:
a light-shielding body;
a light through hole, penetrating through a center of the light-shielding body; and
at least one identification region, penetratively disposed at a periphery of the light-shielding body, wherein one of the at least one identification region comprises a straight edge located at a boundary of the light-shielding body,
wherein the light-shielding plate adapted to the lens satisfies:
Rs/R≧0.8,
wherein R is a radius of the light-shielding body, and Rs is a shortest distance between the identification region located closest to the light through hole and a circle center of the light through hole.

2. The light-shielding plate adapted to the lens as claimed in claim 1, wherein the light-shielding plate adapted to the lens satisfies: R−Rs≦0.4 mm.

3. The light-shielding plate adapted to the lens as claimed in claim 2, wherein the light-shielding plate comprises two identification regions penetratively disposed at the periphery of the light-shielding body, and an included angle between directions from the center of the light-shielding body to the identification regions is not equal to 180 degrees.

4. The light-shielding plate adapted to the lens as claimed in claim 2, wherein one of the at least one identification region comprises a short straight edge located at a boundary of the light-shielding body and a long straight edge connected to the short straight edge and the light-shielding body, and a length of the long straight edge is longer than a length of the short straight edge.

5. The light-shielding plate adapted to the lens as claimed in claim 2, wherein one of the at least one identification region comprises a pair of short straight edges located at a boundary of the light-shielding body and spaced from each other and a long straight edge connected to the short straight edges through two ends thereof, and a length of the long straight edge is longer than a length of each of the short straight edges.

6. A light-shielding plate adapted to a lens, comprising:
a light-shielding body;
a light through hole, penetrating through a center of the light-shielding body; and
at least one identification region, penetratively disposed at a periphery of the light-shielding body,
wherein the light-shielding plate adapted to the lens satisfies:
Rs/R≧0.8,
R≦3 mm, and
R₀≦1.5 mm,
wherein R is a radius of the light-shielding body, Rs is a shortest distance between the identification region located closest to the light through hole and a circle center of the light through hole, and R₀ is a radius of the light through hole.

7. The light-shielding plate adapted to the lens as claimed in claim 6, wherein the light-shielding plate comprises two identification regions penetratively disposed at the periphery of the light-shielding body, and an included angle between directions from the center of the light-shielding body to the identification regions is not equal to 180 degrees.

8. The light-shielding plate adapted to the lens as claimed in claim 6, wherein one of the at least one identification region comprises a straight edge located at a boundary of the light-shielding body.

9. The light-shielding plate adapted to the lens as claimed in claim 6, wherein one of the at least one identification region comprises a short straight edge located at a boundary of the light-shielding body and a long straight edge connected to the short straight edge and the light-shielding body, and a length of the long straight edge is longer than a length of the short straight edge.

10. The light-shielding plate adapted to the lens as claimed in claim 6, wherein one of the at least one identification region comprises a pair of short straight edges located at a boundary of the light-shielding body and spaced from each other and a long straight edge connected to the short straight edges through two ends thereof, and a length of the long straight edge is longer than a length of each of the short straight edges.
